(19) United States
(12) Patent Application Publication
(10) Pub. No.: US 2019/0176533 A1
(43) Pub. Date: Jun. 13, 2019

(54) PNEUMATIC TIRE

(71) Applicant: Toyo Tire & Rubber Co., Ltd., Itami-shi (JP)

(72) Inventor: Toshikazu Yasunaga, Itami-shi (JP)

(73) Assignee: Toyo Tire & Rubber Co., Ltd., Itami-shi (JP)

(21) Appl. No.: 16/210,824

(22) Filed: Dec. 5, 2018

(30) Foreign Application Priority Data
Dec. 13, 2017 (JP) 2017-238877

(51) Int. Cl. B60C 11/12; B60C 11/04

(52) U.S. Cl. CPC B60C 11/1204; B60C 11/1236; B60C 11/1272; B60C 2011/0346; B60C 2011/1213; B60C 2011/1227; B60C 2011/1245; B60C 11/042

(57) ABSTRACT

To prevent an interrupted portion in a sipe in a case in which a pneumatic tire with a sipe continuous in a tire circumferential direction has a pitch variation. A pneumatic tire according to an embodiment includes a tread portion 10 in which a plurality of pitch patterns having different pitch lengths are arranged in a tire circumferential direction. A rib extending in the tire circumferential direction of the tread portion is provided with a sipe continuous in the tire circumferential direction. The sipe is formed by repeating a sipe component in the tire circumferential direction and each pitch pattern includes the plurality of sipe components. A position in the sipe component at each boundary between the pitch patterns is set to the same position and a length of the sipe component in the tire circumferential direction is set according to the pitch lengths of the pitch pattern.

### CROSS-REFERENCE TO RELATED APPLICATIONS

This application is based upon and claims the benefit of priority from the prior Japanese Patent Application No. 2017-238877, filed on Dec. 13, 2017; the entire contents of which are incorporated herein by reference.

### BACKGROUND

### 1. Technical Field

An embodiment of the present invention relates to a pneumatic tire.

### 2. Description of the Related Art

Conventionally, for example, JP-A-2007-030686 discloses a technique in which a zigzag-shaped sipe continuously extending in a tire circumferential direction using a tire width direction as an amplitude direction is provided in order to improve performance of a pneumatic tire on icy and snowy roads.

Meanwhile, in order to reduce pitch noise as tire noise, there is known a technique in which a plurality of pitch patterns having different pitch lengths are arranged in a tire circumferential direction to form a tread portion so that a tread pattern has a pitch variation (see JP-A-2014-221573).

### SUMMARY

In a case in which the tread pattern has a pitch variation when the sipe continuous in the tire circumferential direction is provided in the tread portion, a problem arises in that an interrupted portion is formed in the sipe at a boundary between the pitch patterns.

For example, as in a comparative example illustrated in FIG. 4, a case in which a rib 100 extending in a tire circumferential direction CD is provided with a zigzag-shaped sipe 102 extending in the tire circumferential direction CD is considered. The pitch length is set as three types of Pl, Pm, and Ps in order from the large pitch length and the pitch patterns are set as 104, 106, and 108. The sipe 102 extends in the tire circumferential direction while alternately swinging to the right and left sides in the tire width direction and a sipe component 110 as a repeating unit is repeated in the tire circumferential direction.

The length of the sipe component 110 in the tire circumferential direction is generally uniform and the pitch lengths Pl, Pm, and Ps are adjusted by changing the number of times of repeating the sipe component 110 of each of the pitch patterns 104, 106, and 108.

However, since it is difficult to adjust each of the pitch lengths P1, Pm, and Ps just by changing the number of times of repeating the sipe component 110, an interrupted portion 114 is formed in the sipe 102 at each boundary 112 of the pitch patterns 104, 106, and 108 as illustrated in FIG. 4. When such an interrupted portion 114 is formed, the rigidity of the portion increases so that the ground contact pressure distribution becomes non-uniform and uneven wear occurs.

In view of the above-described circumstances, an object of an embodiment of the invention is to prevent an interrupted portion in a sipe in a case in which a pneumatic tire with a sipe continuous in a tire circumferential direction has a pitch variation.

A pneumatic tire according to an embodiment of the invention is a pneumatic tire including: a tread portion in which a plurality of pitch patterns having different pitch lengths are arranged in a tire circumferential direction, in which a rib formed in the tread portion and extending in the tire circumferential direction is provided with a sipe continuous in the tire circumferential direction, in which the sipe is formed by repeating a sipe component in the tire circumferential direction, each pitch pattern includes a plurality of the sipe components, and a position in the sipe component at each boundary between the pitch patterns is set to the same position, and in which a length of the sipe component in the tire circumferential direction is set according to the pitch length of the pitch pattern.

According to the embodiment, since it is possible to prevent an interrupted portion in a sipe in a case in which a pneumatic tire with a sipe continuous in a tire circumferential direction has a pitch variation, it is possible to obtain a uniform ground contact pressure distribution and to prevent uneven wear.

### BRIEF DESCRIPTION OF THE DRAWINGS

FIG. 1 is a developed view illustrating a tread pattern of a pneumatic tire according to an embodiment.

FIG. 2 is a plan view illustrating a center land portion of the tread pattern.

FIG. 3 is an enlarged plan view of the center land portion.

FIG. 4 is a plan view illustrating a center land portion of a tread pattern according to a comparative example.

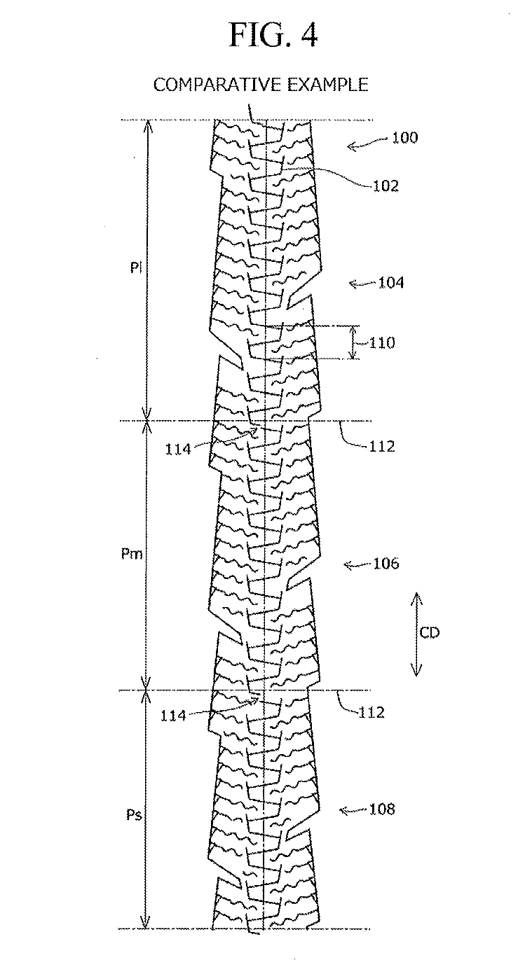

### DETAILED DESCRIPTION

Hereinafter, an embodiment will be described with reference to the drawings.

Although not illustrated in the drawings, a pneumatic tire according to an embodiment includes a pair of right and left bead portions, a pair of right and left sidewall portions, and a tread portion provided between both sidewall portions to connect outer end portions of the right and left sidewall portions in the radial direction and a general tire structure can be used for a structure other than a tread pattern.

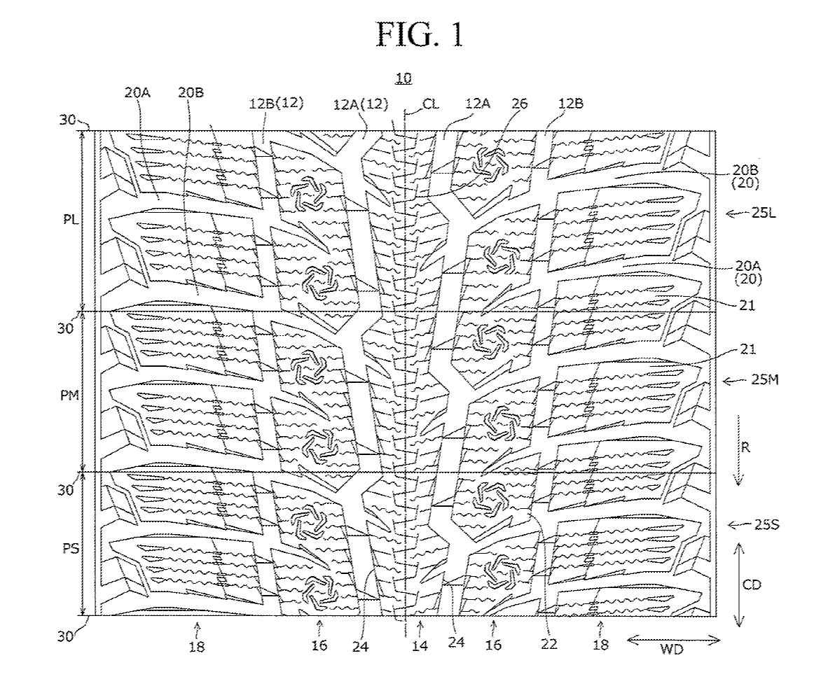

As illustrated in FIG. 1, a tread rubber surface of a tread portion 10 is provided with a plurality of main grooves 12 extending in a tire circumferential direction CD and in this example, four main grooves are formed at intervals in a tire width direction WD. That is, a pair of center main grooves 12A and 12A provided at both sides of a tire equator CL and a pair of shoulder main grooves 12B and 12B respectively disposed at the outside thereof are provided. Four main grooves 12 are zigzag-shaped grooves which extend in the tire circumferential direction CD while being bent with an amplitude in the tire width direction WD.

The pneumatic tire is a tire having a specified rotation direction and in the drawings, the rotation direction is indicated by Reference Sign R. The pneumatic tire is attached to a vehicle so that the tire rotates in a direction indicated by the arrow R when the vehicle runs forward. As a mark for this purpose, a display for designating the rotation direction is provided on, for example, the sidewall portion or the like of the pneumatic tire.

In the tread portion 10, a plurality of land portions are divided by the main groove 12 in the tire width direction WD. Specifically, a center land portion 14 interposed between the pair of center main grooves 12A and 12A, a pair of right and left intermediate land portions 16 and 16 interposed between the center main groove 12A and the shoulder main groove 12B, and a pair of right and left shoulder land portions 18 and 18 located at the outside of the shoulder main groove 12B in the tire width direction are provided.

In the tread portion 10, a plurality of lateral grooves 20 extending in the tire width direction WD are provided at intervals in the tire circumferential direction CD. As the lateral groove 20, a first lateral groove 20A which opens to a ground contact end, obliquely extends in a curved shape from the ground contact end toward a tire equator CL, and is terminated inside an intermediate land portion 16 and a second lateral groove 20B which opens to a ground contact end, obliquely extends in a curved shape from the ground contact end toward the tire equator CL, and is terminated inside the center land portion 14 are provided. The first lateral groove 20A and the second lateral groove 20B are alternately provided in the tire circumferential direction CD. Further, the first lateral grooves 20A are provided with the phases shifted from each other on the right and left sides of the tire equator CL and the second lateral grooves 20B are also provided with the phases shifted from each other on the right and left sides of the tire equator CL.

Accordingly, the shoulder land portion 18 is divided by the first lateral groove 20A and the second lateral groove 20B to be formed as a block row in which a plurality of shoulder blocks 21 are arranged in the tire circumferential direction CD. Further, the intermediate land portion 16 is divided by the second lateral groove 20B to be formed as a block row in which an intermediate block 22 that is twice the length of the shoulder block 21 is disposed in the tire circumferential direction CD.

Meanwhile, the center land portion 14 which is located on the tire equator CL is not divided by the lateral groove 20 and extends in the tire circumferential direction CD. That is, the center land portion 14 is formed as a rib which is continuous in the entire circumference of the tire circumferential direction CD. In the center land portion 14, the right and left side walls 24 and 24 are formed in a zigzag shape by both zigzag-shaped center main grooves 12A and 12A. Further, the center land portion 14 is provided with the leading end portions of the second lateral grooves 20B which are alternately formed at the right and left sides at intervals in the tire circumferential direction CD.

As illustrated in FIG. 1, the tread portion 10 is formed by arranging a plurality of pitch patterns having different pitch lengths in the tire circumferential direction CD. In this example, the pitch length is set to three types and is set as PL, PM, and PS in order of the large pitch length. Thus, a pitch pattern 25L of the pitch length PL, a pitch pattern 25M of the pitch length PM, and a pitch pattern 25S of the pitch length PS are provided. Here, the pitch pattern indicates the minimum unit of the component of the thread pattern repeated in the tire circumferential direction (the minimum component unit in the tire circumferential direction). In this example, the pitch lengths PL, PM, and PS are defined by the lengths corresponding to two of the shoulder block 21 of the shoulder land portion 18. This is the same as the length corresponding to one of the intermediate block 22 in the intermediate land portion 16 and is the same as the length corresponding to a gap between the second lateral grooves 20B and 20B of one side wall 24 of the center land portion 14.

The center portion of the center land portion 14 is provided with a zigzag-shaped sipe 26 which continuously extends in the tire circumferential direction CD. The zigzag-shaped sipe 26 is a sipe which does not open to the main groove 12 and is a wavy sipe of which an amplitude direction is substantially the same as the tire width direction WD. The zigzag-shaped sipe 26 extends in the entire circumference of the tire circumferential direction CD while swinging in the tire width direction WI) with a predetermined amplitude.

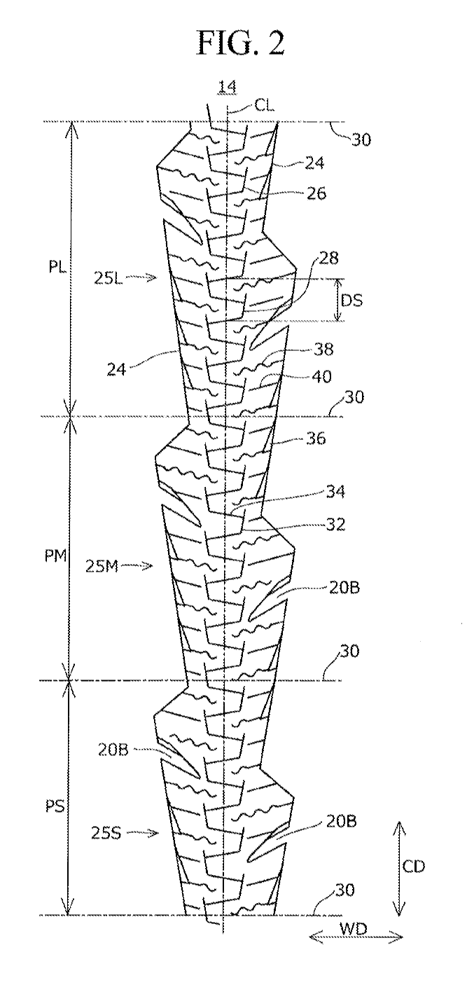

As illustrated in FIG. 2, the zigzag-shaped sipe 26 is formed by repeating a sipe component 28 as a repeating unit in the tire circumferential direction CD. The sipe component 28 is a sipe portion for one wavelength of the zigzag-shaped sipe 26 forming a wave shape. In FIG. 2, the sipe component 28 is illustrated as a sipe portion in a range indicated by Reference Sign DS and the position corresponding to the start point of the repeating unit is not particularly limited as long as a length for one wavelength is provided.

Each of the pitch patterns 25L, 25M, and 25S includes the plurality of sipe components 28 and the sipe is formed in a zigzag shape by the repetition of the sipe component 28 in each of the pitch patterns 25L, 25M, and 25S.

As illustrated in FIG. 2, a position in the sipe component 28 at each of the boundaries 30 between the pitch patterns 25L, 25M, and 25S is set to the same position. That is, the zigzag-shaped sipe 26 is set to straddle a boundary 30 at the same position (the same phase) of the sipe component 28 in any boundary 30 when straddling the boundary 30 of the adjacent pitch patterns 25L, 25M, and 25S and the phase of the sipe 26 at each straddling portion is the same.

In the embodiment, a length DS (a length for one wavelength) of the sipe component 28 in the tire circumferential direction CD is set according to the pitch lengths PL, PM, and PS of the pitch patterns 25L, 25M, and 25S. Specifically, the number of the sipe components 28 provided in each of the pitch patterns 25L, 25M, and 25S is set so that the length DS of the sipe component 28 is substantially the same in all of the pitch patterns 25L, 25M, and 25S. Then, the sipe components 28 are arranged at the same intervals in each of the pitch patterns 25L, 25M, and 25S with the position of the sipe component 28 at the boundary 30 as a base point. That is, the length DS of the sipe component 28 is set to be uniform in each of the pitch patterns 25L, 25M, and 25S. Meanwhile, since the length DS of the sipe component 28 for each of the pitch patterns 25L, 25M, and 25S is set by the pitch lengths PL, PM, and PS and the number of the sipe components 28, the lengths are generally set to different values. That is, the length DS of the sipe component 28 is generally differently for each of the pitch lengths PL, PM, and PS.

The length DS of the sipe component 28 is preferably set to within ±10% of a range with reference to a median value of the length DS of the sipe component 28 (that is, 90 to 110% of the median value) in the plurality of pitch patterns 25L, 25M, and 25S having different pitch lengths PL, PM, and PS. For example, in the example illustrated in FIG. 2, the number of the sipe components 28 is seven in the pitch pattern 25L having a long pitch length PL, six in the reference pitch pattern 25M having an intermediate pitch length PM, and five in the pitch pattern 25S having a short pitch length PS and the length DS of the sipe component 28 is 10.54 mm, 10.98 mm, and 11.72 mm, respectively. Thus the length DS of each of the pitch patterns 25L and 25S is within ±10% of a range with reference to a median value of the length DS (=10.98 mm) of the pitch pattern 25M.

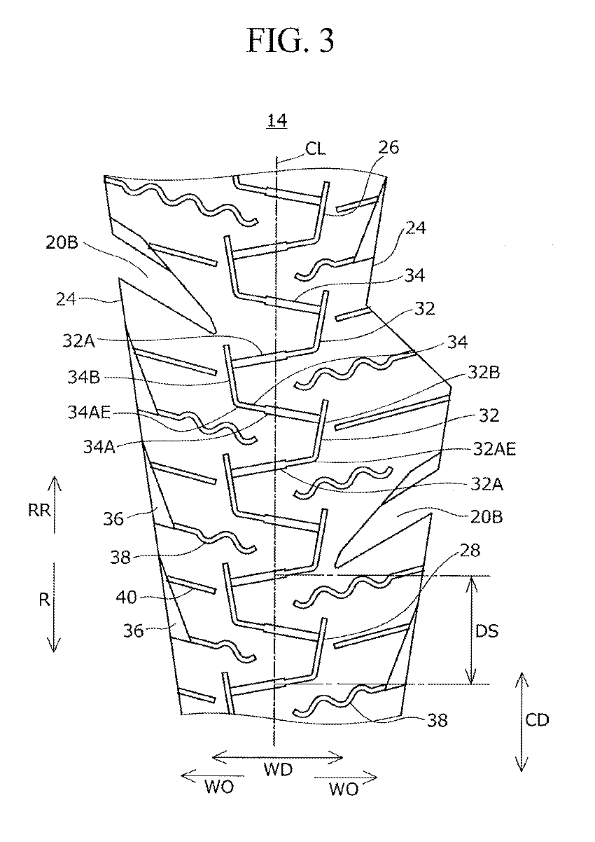

As illustrated in FIG. 3, the zigzag-shaped sipe 26 has a zigzag-shaped (that is, winding-shaped) cross-section by alternately arranging a first L-shaped sipe 32 and a second L-shaped sipe 34 in the tire circumferential direction CD. The first L-shaped sipe 32 has an L-shaped cross-section by a lateral sipe portion 32A extending in the tire width direction WD and a longitudinal sipe portion 32B extending in the tire circumferential direction CD from one end portion 32AE of the lateral sipe portion 32A in the tire width direction WD. The second L-shaped sipe 34 has a L-shaped cross-section by a lateral sipe portion 34A extending in the tire width direction WD and a longitudinal sipe portion 34B extending in the tire circumferential direction CD from the other end portion 34AE of the lateral sipe portion 34A in the tire width direction WD (that is, an end portion opposite to one side of the end portion 32AE).

In the first L-shaped sipe 32 and the second L-shaped sipe 34, a common member is used as a sipe forming piece for forming the first and second L-shaped sipes and the first and second L-shaped sipes have the same shape when the first and second L-shaped sipes are rotated about the rotation axis along the tire equator line by 180°.

The zigzag-shaped sipe 26 is formed by connecting the front end of the lateral sipe portion 34A of the second L-shaped sipe 34 to the side surface of the longitudinal sipe portion 32B of the first L-shaped sipe 32 in an abutting state and connecting the front end of the lateral sipe portion 32A of the first L-shaped sipe 32 to the side surface of the longitudinal sipe portion 34B of the second L-shaped sipe 34 in an abutting state. The connection positions of the lateral sipe portions 32A and 34A and the longitudinal sipe portions 32B and 34B between the first L-shaped sipe 32 and the second L-shaped sipe 34 are different, and thereby the length DS of the sipe component 28 is set to a different value. Specifically, when the lateral sipe portions 32A and 34A abut at a position close to the front ends of the longitudinal sipe portions 32B and 34B, the length DS of the sipe component 28 increases. In contrast, when the lateral sipe portions 32A and 34A abut at a position away from the front ends of the longitudinal sipe portions 32B and 34B, the length DS of the sipe component 28 decreases.

As illustrated in FIG. 3, the lateral sipe portions 32A and 34A have a straight cross-sectional shape and are inclined with respect to the tire width direction WD. Further, the longitudinal sipe portions 32B and 34B have a straight cross-sectional shape and are inclined with respect to the tire circumferential direction CD. However, the lateral sipe portions 32A and 34A and the longitudinal sipe portions 32B and 34B may be formed in a curved shape, a straight shape, or a combination thereof.

The lateral sipe portions 32A and 34A which are adjacent to each other in the tire circumferential direction CD are inclined in the opposite directions with respect to the tire width direction WD). The longitudinal sipe portions 32B and 34B are inclined to the outside WO in the width direction toward the rear side RR in the rotation direction. That is, the longitudinal sipe portions 32B and 34B are formed in an outward opening shape. Here, the rear side RR in the rotation direction is an opposite direction with respect to the rotation direction R. Further, the outside WO in the width direction indicates a direction moving away from the center (amplitude center) of the zigzag-shaped sipe 26 in the width direction and is the same as the outside in the tire width direction WD in this example.

Further, a triangular notch portion 36 is provided in each of both side walls 24 and 24 of the center land portion 14 and the notch portion 36 is provided at a plurality of positions at intervals in the tire circumferential direction CD. Further, in the center land portion 14, a wavy sipe 38 and a straight sipe 40 extending in the tire width direction WD are alternately disposed in the tire circumferential direction CD. Basically, the wavy sipe 38 and the straight sipe 40 are provided to open to the side wall 24 of the center land portion 14 and are terminated so as not to intersect the zigzag-shaped sipe 26.

According to the pneumatic tire of the embodiment with the above-described configuration, the zigzag-shaped sipe 26 is continuously formed in the tire circumferential direction CD. Here, the position of the sipe component 28 at the straddling portions of the pitch patterns 25L, 25M, and 25S is set to the same position in any boundary 30 of the pitch patterns 25L, 25M, and 25S and the length DS of the sipe component 28 is set according to the pitch lengths PL, PM, and PS of the pitch patterns 25L, 25M, and 25S. Accordingly, since the zigzag-shaped sipe 26 is not interrupted at the boundary 30 of the pitch patterns 25L, 25M, and 25S, it is possible to obtain a uniform ground contact pressure distribution and to suppress uneven wear.

Further, since the length DS of the sipe component 28 is set to a range of ±10%, the length DS is substantially the same in all of the pitch patterns 25L, 25M, and 25S and hence the ground contact pressure distribution becomes further uniform.

Further, it is possible to commonly use the sipe forming piece when the zigzag-shaped sipe 26 is formed by the combination of the first L-shaped sipe 32 and the second L-shaped sipe 34. At the same time, it is possible to easily change the length DS of the sipe component 28 when the connection position between both members is changed. As a result, it is possible to simply set the length DS of the sipe component 28 according to the pitch lengths PL, PM, and PS of the pitch patterns 25L, 25M, and 25S.

Furthermore, in the above-described embodiment, the zigzag-shaped sipe is provided as the sipe which is continuous in the tire circumferential direction, but the shape of the sipe is not limited as long as the sipe has a repeated pattern and is continuous in the tire circumferential direction. Further, in the above-described embodiment, an example in which the sipe continuous in the tire circumferential direction is provided in the center land portion has been described, but there is no limitation in the configuration in which the sipe is provided in the center land portion. Further, the pitch pattern may not be formed in the entire tread portion in the width direction and may be formed only by the land portion provided with the sipe continuous in the tire circumferential direction. Further, in the above-described embodiment, the pitch length is set to three types, but the invention is not limited thereto. For example, five types may be provided or five or more types may be provided.

Furthermore, the dimensions in the specification are those in a normal state without any load in a state in which a pneumatic tire is mounted on a regular rim and is filled with a normal internal pressure. The regular rim is “Standard Rim” in the JATMA standard, “Design Rim” in the TRA standard, or “Measuring Rim” in the ETRTO standard. The normal internal pressure is “MAXMIMUM AIR PRESSURE” in the JATMA standard, the “maximum value” described in “TIRE LOAD LIMITS AT VARIOUS COLD INFLATION PRESSURES” in the TRA standard, or “INFLATION PRESSURE” in the ETRTO standard.

As the pneumatic tire according to the embodiment, tires for various vehicles such as a tire for a passenger car and a heavy duty tire for a truck, a bus, or a light truck (for example, a SUV car and a pickup truck) can be exemplified. Further, the application of the pneumatic tire is not particularly limited and the pneumatic tire may be used as all season tires and winter tires.

Although several embodiments have been described above, these embodiments have been suggested as an example and are not intended to limit the scope of the invention. These embodiments can be implemented in various other forms and can be implemented while being omitted, replaced, or changed in various ways without departing from the gist of the invention. These embodiments and modifications thereof are included in the scope and gist of the invention as well as in the scope of the invention described in the claims and their equivalents.

What is claimed is:

1. A pneumatic tire comprising:
a tread portion in which a plurality of pitch patterns having different pitch lengths are arranged in a tire circumferential direction,
wherein a rib formed in the tread portion and extending in the tire circumferential direction is provided with a sipe continuous in the tire circumferential direction,
wherein the sipe is formed by repeating a sipe component in the tire circumferential direction, each pitch pattern includes a plurality of the sipe components, and a position in the sipe component at each boundary between the pitch patterns is set to the same position, and
wherein a length of the sipe component in the tire circumferential direction is set according to the pitch length of the pitch pattern.

2. The pneumatic tire according to claim 1,
wherein the sipe is a zigzag-shaped sipe in which a first L-shaped sipe including a lateral sipe portion and a longitudinal sipe portion extending from one end portion thereof in a tire width direction and a second L-shaped sipe including a lateral sipe portion and a longitudinal sipe portion extending from the other end portion thereof in the tire width direction are alternately arranged in the tire circumferential direction, and a connection position of the lateral sipe portion and the longitudinal sipe portion between the first L-shaped sipe and the second L-shaped sipe is different so that the length of the sipe component is set to a different value.

3. The pneumatic tire according to claim 1,
wherein the length of the sipe component is set within a range of ±10% with reference to a median value of the length of the sipe component in the plurality of pitch patterns having different pitch lengths.

4. The pneumatic tire according to claim 2,
wherein the length of the sipe component is set within a range of ±10% with reference to a median value of the length of the sipe component in the plurality of pitch patterns having different pitch lengths.
